(19) United States
(12) Patent Application Publication
(10) Pub. No.: US 2013/0331958 A1
(43) Pub. Date: Dec. 12, 2013

(54) METHOD AND APPARATUS FOR MANAGING DEVICES

(71) Applicants: Charles Edgar Bess, McKinney, TX (US); Guy Mitchell, Aurora, CO (US); Max Bohm, Holzwickede NRW (DE); Roy James Pratt, III, Youngstown, OH (US)

(72) Inventors: Charles Edgar Bess, McKinney, TX (US); Guy Mitchell, Aurora, CO (US); Max Bohm, Holzwickede NRW (DE); Roy James Pratt, III, Youngstown, OH (US)

(73) Assignee: HEWLETT-PACKARD DEVELOPMENT COMPANY, L.P., Houston, TX (US)

(21) Appl. No.: 13/985,808

(22) PCT Filed: Feb. 23, 2011
(86) PCT No.: PCT/US11/25895

§ 371 Date: Aug. 15, 2013

(51) Int. Cl. G05B 15/02

(52) U.S. Cl. CPC G05B 15/02
USPC 700/12

(57) ABSTRACT

According to one example of the present invention, there is provided apparatus for managing a group of resource consuming devices. The apparatus comprises a resource monitoring module to obtain resource consumption characteristics of devices in the group of devices, and to obtain a desired consumption characteristic for the group of devices. The apparatus further comprises a device control module to receive a request to modify the operating state of a device in the group of devices, determine the consequence on the desired group characteristic of accepting the request, determine whether the consequence is acceptable and, where it is so determined, modifying the operating state of the device in accordance with the request.

### BACKGROUND

Many organizations and businesses are becoming increasingly focused on reducing their environmental impact, whilst at the same time having to make increased use of resource consuming devices, such as electricity consuming devices. Examples of electricity consuming devices include: computing devices, such as, computers, servers, network devices, telecommunication devices, and storage devices; medical devices, such as scanners and life-support machines; cooling equipment, such as air conditioning units; and manufacturing machines. Other resource consuming devices include fuel consuming devices, such as heating systems, boilers, and the like.

Until recently, organizations have generally paid little regard to the management of resources being consumed, other than perhaps trying to use devices that make efficient use of resources, such as Energy Star certified devices for some electricity consuming devices.

However, improved management of resource consuming devices may enable organizations and businesses to further reduce the amount of resources they consume, and reduce associated expenses.

### BRIEF DESCRIPTION

Examples and embodiments of the present invention will now be described, by way of non-limiting example only, with reference to the accompanying drawings, in which:

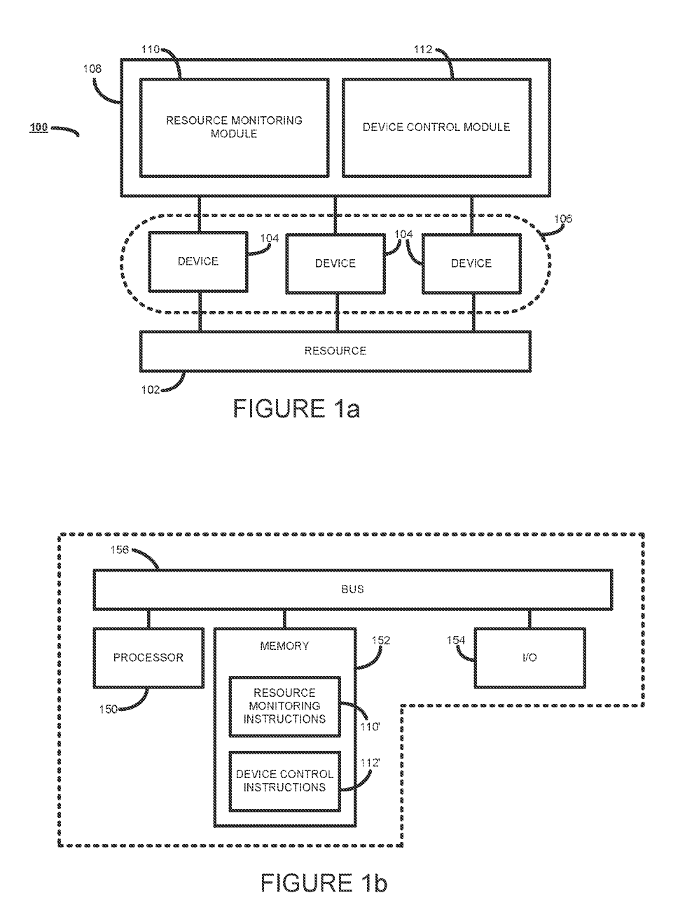

FIG. 1a is a simplified block diagram of a system according to an example of the present invention;

FIG. 1b is a simplified block diagram of a system according to an example of the present invention;

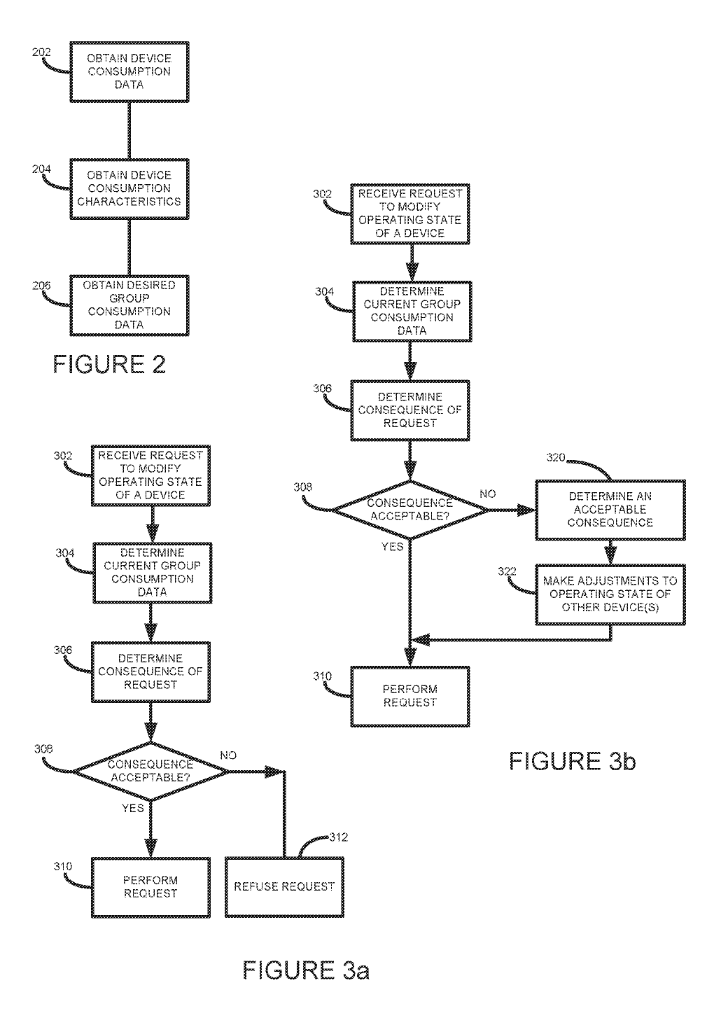

FIG. 2 is a simplified flow diagram outlining a method of operating part of a system according to an example of the present invention;

FIG. 3a is a simplified flow diagram outlining a method of operating part of a system according to an example of the present invention;

FIG. 3b is a simplified flow diagram outlining a method of operating part of a system according to an example of the present invention;

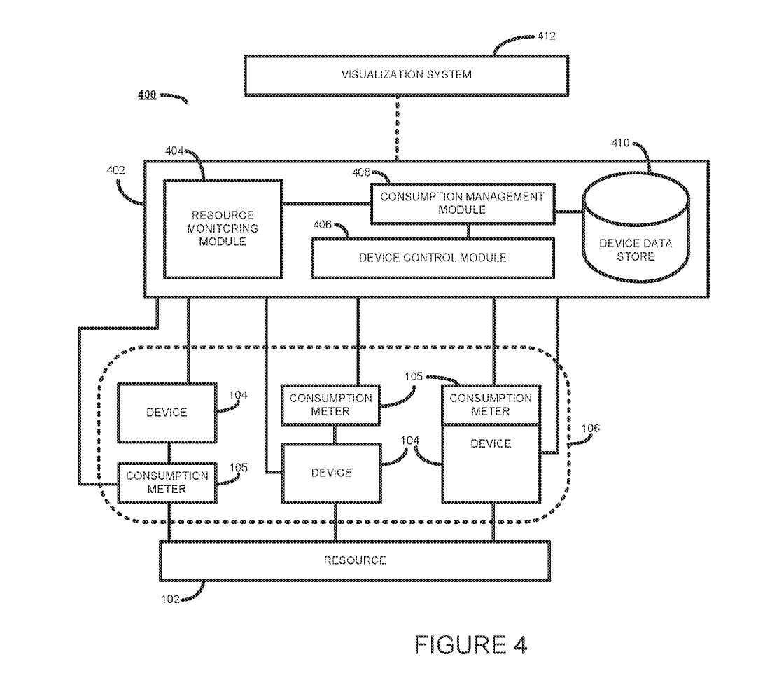

FIG. 4 is a simplified block diagram of a system according to an example of the present invention;

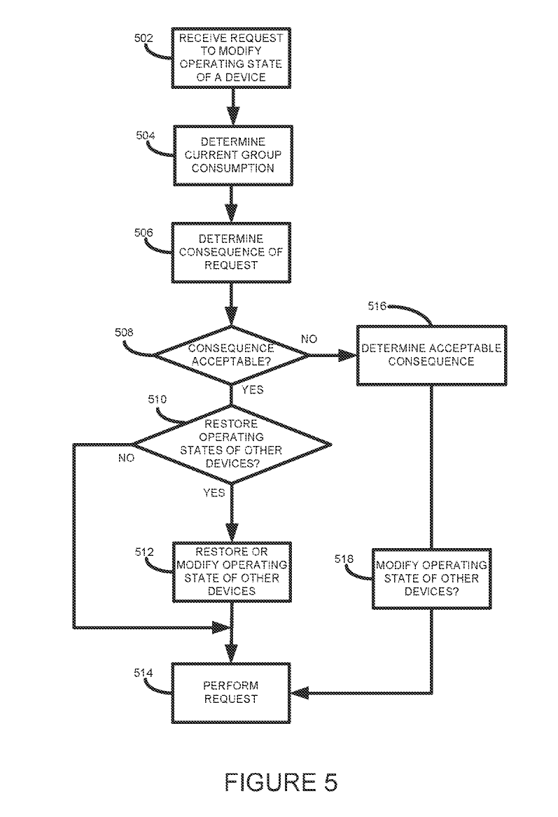

FIG. 5 is simplified flow diagram outlining a method of operating part of a system according to an example of the present invention;

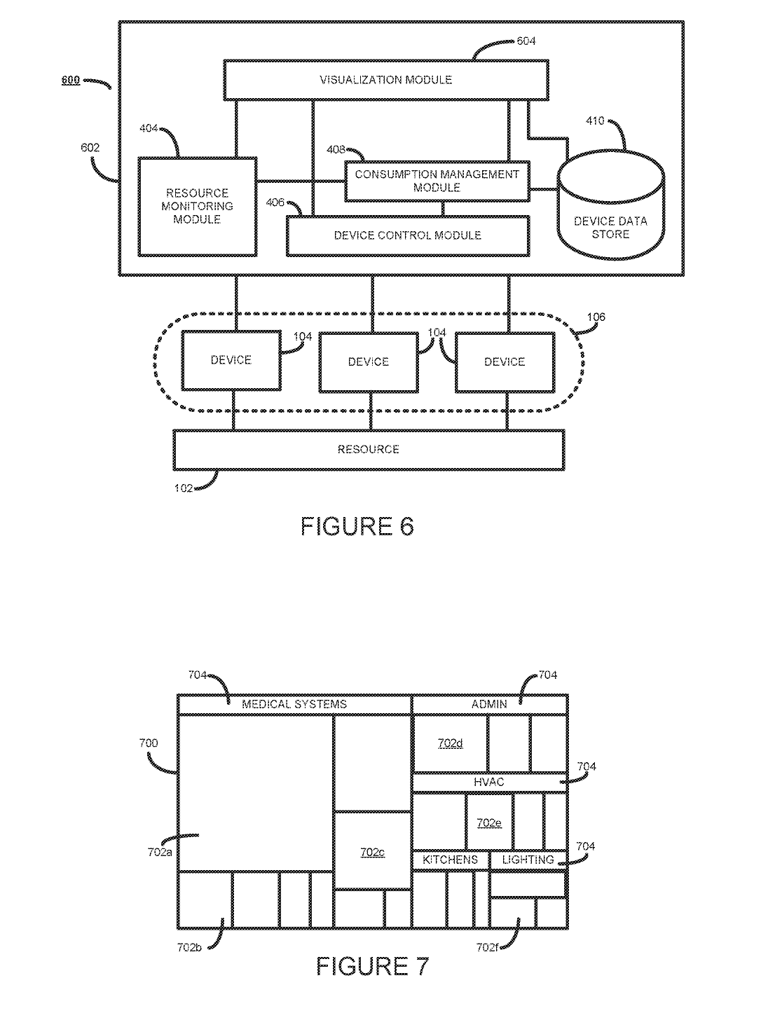

FIG. 6 is a simplified block diagram of a system according to an example of the present invention; and

FIG. 7 is simplified diagram illustrating a visualization and user interface according to an example of the present invention.

### DETAILED DESCRIPTION

Referring now to FIG. 1 there is shown a system 100 according to one example of the present invention. The operation of elements of the system 100 is described with additional reference to the flow diagrams of FIGS. 2, 3a, and 3b.

The system 100 includes a number of resource consuming devices 104 that, when operating, consume resource 102. Each device 104 is identifiable by a device identifier. The devices 104 form a group of devices 106. The group of devices 106 may, for example, be a group of devices of an organization or business or be a sub-group of a group of devices of an organization or business.

In one example the resource 102 is electricity, and the devices 104 are electricity consuming devices. In another example, the resource 102 is a fuel, such as natural gas, propane, heating fuel, diesel, wood pellets, or the like, and the devices 104 are fuel consuming devices. In further examples, the resource 102 may be a gas or a liquid, and the devices 104 may be gas or liquid consuming devices.

The system 100 includes a device management system 108. The device management system 108 comprises a resource monitoring module 110 and a device control module 112.

The resource monitoring module 110 obtains (202 in FIG. 2) consumption data of each of the devices 104 in the group of devices 106. In one example the obtained consumption data includes instantaneous or near-instantaneous consumption data, indicating the amount of resource 102 currently being or recently consumed by a device. For example, if the resource 102 is electricity, the obtained consumption data may include the electrical power being consumed by a device, the current being drawn, etc. The consumption data may be obtained in any suitable manner, such as electronically, and may be obtained directly from a device or from a resource consumption meter associated with a device.

The device control module 112 additionally obtains (204) device consumption characteristics relating to each device.

In one example the device consumption characteristics are obtained electronically by the device control module 112 from each device 104. In a further example the device consumption characteristics are obtained from device data sheets, device data databases, or in any other suitable manner.

The device consumption characteristics may include, for example, data relating to the maximum estimated resource consumption rate (DeviceConsumption_{MAX}), the minimum estimated resource consumption rate (DeviceConsumption_{MIN}), the average estimated resource consumption rate (DeviceConsumption_{AVE}), and so on. Where the resource 102 is electricity, consumption characteristics may include any suitable electrical characteristics, including: voltage, current, power, resistance, and induction, characteristics.

The device consumption characteristics may additionally include device management data. Device management data may include, for example, data indicating whether a device can be powered down, data indicating a priority or importance level of a device within the group of devices 106, data indicating whether the device may be operated in a reduced power mode, and data indicating a maximum period during which the device may be powered down or operated in a reduced power mode.

The device control module 112 additionally obtains (206) desired or target group resource consumption data relating to the group of devices 106. The desired group resource consumption data may be selected or defined, for example, by a manager or administrator of the organization with which the devices are associated. The desired group consumption data may include, for example, data relating to a maximum desired consumption rate (GroupTargetConsumption_{MAX}), a desired average consumption rate (GroupTargetConsumption_{AVE}), and so on. Where the resource 102 is electricity, desired group consumption data may include any suitable electrical characteristics, including: voltage, current, power, resistance, and induction, characteristics,

Referring now to FIG. 3a, there is shown a flow diagram outlining a method of operating the device management system 108 according to an example of the present invention. In the present example, the device management system 108 is used to control or change the operating state of devices 104 in the group of devices 106.

At 302 the device control module 112 receives a request to modify the operating state of one of the devices 104 of the group of devices 106. The request may include, for example, a request to power-on a currently inactive device, a request to power-down a currently active device, and a request to change the power mode of a currently active device (e.g. to run in a low, high, or normal power mode).

At 304 the device control module 112 determines (304) the present consumption data of the group of devices 106, using for example the previously obtained consumption data for each device 104. For example, the device control module 112 may determine, or calculate, the current instantaneous, or near-instantaneous, resource consumption (GroupConsumption_{INST}) for the group of devices 106.

At 306 the device control module 112 determines the consequence or consequences of accepting the received request. The consequence(s) may be determined, for example, by estimating the effect on the group consumption data should the request be accepted. For example, the consequence may be that the overall group consumption data, if the request were to be accepted, would exceed the desired group resource consumption level (GroupTargetConsumption_{MAX}) for the group. In another example, the consequence may be that the group consumption data, if the request were to be accepted, would remain below the desired group resource consumption level (GroupTargetConsumption_{MAX}). The consequence of the desired group resource consumption level being exceed may negatively impact the operation of devices 104, for example, by causing fuses to blow, capacity overload, low resource pressure, and the like. In turn, this may have a negative impact on the operation of the organization.

At 308 the device control module 112 determines whether the determined consequence or consequences of accepting the request are acceptable. If yes, the device control module 112 performs (310) the request, and modifies the operating state of the device identified in the request accordingly. If not, the device control module 112 refuses the request (312).

A further example according to the present invention is shown in the flow diagram of FIG. 3b. In this example, if the device control module 112 determines (308) that the consequence is not acceptable it determines (320) an alternative consequence that is acceptable. For example, the device control module 112 identifies one or several of the devices 104 in the group of devices 106 for which the operating state or states may be modified, in accordance with any device consumption characteristics and device management data, such that the alternative consequence of accepting the request is acceptable.

At 322 the device control module modifies the operating state of any devices identified at 320, before performing (310) the request.

In one example, illustrated in FIG. 1b, at least part of the device management system 108 may be implemented using a microprocessor 150 coupled, via a communication bus 156, to a memory 152 and an input/output module 154. The memory 152 stores device management system instructions comprising resource monitoring instructions 110 and device control instructions 112′. The instructions 110′ and 112′ are processor understandable instructions that when executed by the processor 150 provide functionality of the device management system 108, the resource monitoring module 110, and the device control module 112 as described herein.

Referring now to FIG. 4 there is shown a more detailed illustration of a system 400 according to a further example of the present invention. Like reference numerals are used to denote similar, but not necessarily identical, elements.

A number of resource consuming devices 104 form part of a group of devices 106. Each device 104 is identifiable by a device identifier. During operation each of the devices 104 consume resource 102. The amount of resource 102 consumed by each device 104 is determined or measured by a consumption meter 105 associated with the device. The consumption meters 105 may be any suitable consumption meter. For example, as shown in FIG. 4, a consumption meter may be placed between the resource and the device, may be placed after the device, or may be integrated with the device.

The operation of at least part of the functionality of each of the devices 104 is controlled by a device management system 402. The device management system 402 comprises a resource monitoring module 404, a device control module 406, a consumption management module 408, and a device data store 410,

The resource monitoring module 404 obtains consumption data from each of the devices 104 or from each of their associated consumption meters, as appropriate. As previously described, the obtained consumption data may include the instantaneous, or near-instantaneous, resource consumption rate for a device.

The device control module 406 is able to control an operating state of each of each of the devices 104 by sending appropriate commands, messages, control signals, or the like, to the device. The device control module 406 may communicate with each of the devices 104 in any suitable manner, including via a wired communication channel or a wireless communication channel.

In one example, modifications to the operating state of a device are requested through the device control module 406. For example, the device control module 406 may present a suitable user interface to an operator, who may then select a particular device 104 and select a desired operating state for that device. In a further example, modifications to the operating state of a device are requested through the device itself. In this example, the device sends a request to the device control module 406 for it to modify its operating state, and the device control module 406 appropriately authorizes or denies the request.

The device control module 406 additionally obtains device consumption characteristics relating to each device and stores them in the device data store 410. As previously described, in one example the device consumption characteristics may be obtained electronically by the device control module 406 from each device 104, and in a further example the device consumption characteristics may be obtained from device data sheets, device data databases, or in any other suitable manner.

The device consumption characteristics may include, for example, data relating to the maximum estimated resource consumption rate (DeviceConsumption_{MAX}), the minimum estimated resource consumption rate (DeviceConsumption_{MIN}), the average estimated resource consumption rate (DeviceConsumption_{AVE}), and so on. Where the resource 102 is electricity, consumption characteristics may include any suitable electrical characteristics, including: voltage, current, power, resistance, and induction, characteristics.

The device consumption characteristics may additionally include device management data. Device management data may include, for example, data indicating whether a device can be powered down, data indicating a priority or importance level of a device within the group of devices 106, data indicating whether the device may be operated in a reduced power mode, data indicating a maximum period during which the device may be powered down or operated in a reduced power mode, a time window during which a device may or may not be powered down, and a typical operating period window. For devices that consume different amounts of resource over time, device consumption characteristics may additionally include data indicating the amount of resource consumed over time. In one example, the consumption characteristics are stored in an XML or other suitable mark-up language or electronically understandable format.

Example device consumption characteristics are shown below in Table 1.

TABLE 1
EXAMPLE DEVICE CONSUMPTION CHARACTERISTICS

| | CONSUMPTION | |
|---|---|---|
| DEVICE ID | CHARACTERISTICS | DEVICE MANAGEMENT DATA |
| 001 | MAX = 150 W | Device Priority = 1 |
| | MIN = 50 W | MaxPowerDownTime = |
| | | 15 minutes |
| | AVE = 110 W | DoNotPowerDownWindow = |
| | | 11pm to 7am, |
| | | Sunday to Sunday |
| | | ReducedPowerMode = No |
| | | AveragePowerOnTime = |
| | | 60 minutes |
| 002 | MAX = 3500 W | Device Priority = 2 |
| | MIN = 2000 W | ReducedPowerMode = No |
| | AVE = 3000 W | StartUpConsumpton = 3500 W |
| | | for 2 minutes, then 3000 W |
| | | average |
| . . . | . . . | . . . |

The device control module 406 additionally obtains desired or target group consumption data relating to the resource consumed by the group of devices 106. The desired group consumption data may be selected or defined, for example, by a manager or administrator of the organization with which the devices are associated. The desired group consumption data may include, for example, data relating to a maximum desired consumption rate or level (GroupTargetConsumption_{MAX}), a desired average consumption rate (GroupTargetConsumption_{AVE}), and so on. Where the resource 102 is electricity, group consumption data may include any suitable electrical characteristics, including: voltage, current, power, resistance, and induction, characteristics.

A method of managing a request to modify the operating state of a device 104, in accordance with one example of the present invention, will now be described in further detail with reference to the flow diagram of FIG. 5.

At 502 the device control module 406 receives a request to modify the operating state of a device 104. As previously described, in one example the request may be received either via an interface of the device control module 406, and in a further example the request may be received from a device 104. The request identifies the particular device, for example using the device identifier, and additionally identifies the requested change in operating state. For example, a change in operating state may include a change to power-on a device, to power-down a device, and to operate a device in a modified power mode.

At 504 the resource monitoring module 404 determines the current amount of resource being consumed by the group of devices 106.

At 506 the consumption management module 408 determines the consequence or consequences of accepting the received request to modify the operating state of a device 104. The consequence of accepting the request may be determined by calculating, or estimating, the effect of accepting the request on the group consumption data.

For example, if the request is to power-on a currently inactive device the consequence on the group consumption data would be to increase the group consumption level. If the request is to power-down a currently active device the consequence would be to decrease the group consumption level. The amount of the change is determinable, or may be estimated, from the previously obtained device consumption characteristics.

At 508 the consumption management module 408 determines whether the determined consequence or consequences are acceptable. The determination is based in part on the desired group consumption data and in part on the device consumption characteristics.

For example, if the target maximum consumption level for the group (GroupTargetConsumption_{MAX}) is not exceeded, the consumption management module may determine that the consequence of accepting the requesting is acceptable.

If however, the consequences are determined as being not acceptable, the consumption management module 408 determines (516) an alternative acceptable consequence, or set of consequences, such as, for example, modifying the operating state of one or more of the other devices in the group of devices 106. For example, if accepting the request would cause the maximum consumption level for the group (GroupTargetConsumption_{MAX}) to be exceeded, the consumption management module 408 determines whether the operating state of any other ones of the devices 104 may be changed, within any limitations defined by the device consumption characteristics.

For example, if the request concerns a ‘priority 1’ device, the consumption management module 408 may select or identify one or more lower priority devices to be powered down, to enable the requested device to be powered-on without causing the maximum consumption level for the group (GroupTargetConsumption_{MAX}) to be exceeded. Alternatively, depending on the nature of the other devices 104, the consumption management module 408 may select or identify a device to have its operating state modified to operate in a reduced consumption mode, where available, to temporarily change the operating state of a device, and so on. The consumption management module may also suggest delaying the change in operating state of a device until a later time, for example, once one of the other devices is powered down.

At 518 the consumption management module 408 modifies, through the device control module 406 the operating state of other devices, as determined in 516. At 514 the device control module 406 modifies the operating state of the device identified in the request in accordance with the request.

If, however, the consequences are determined (508) as being acceptable, the consumption management module 408 determines (510) whether any devices which have previously had their operating state modified in 518 may be restored. For instance, if a device was previously powered-down due to a high consumption device being powered-on, it may be possible to restore or modify the operating state of the device. This will depend on the nature of the request and the consequence of doing so has to be acceptable. If the consumption management module 408 determines (510) that it is possible to restore or to modify the operating state of one of the other devices the consumption management module 408 makes the changes (512) through the device control module 406. Otherwise, no changes are made, and the consumption management module 408 performs the request (514).

FIG. 6 shows a system 600 of a further example according to the present invention. The system 600 comprises a device management system 602, similar to the device management system 402, that additionally comprises a visualization module 604.

The visualization module 604 provides a visual display and interface, or graphical user interface (GUI), that enables different characteristics of the devices 104 and the group of devices 106 to be visualized. In one example, as shown in FIG. 7, the visualization module 604 generates a tree map, or grid map, image 700. The tree map 700 comprises a number of cells 702, not of all which are labeled in FIG. 7 for reasons of clarity. Each cell 702 represents a device 104. A group of devices 106 are represented on the tree map by a descriptive group label. Thus, the tree map 700 represents a number of groups of devices having the labels ‘medical systems’, ‘admin’, ‘hvac’, ‘kitchens’, and ‘lighting’.

The size of each cell may be used to represent a characteristic of a device relative to other devices in the group. For example, if the size of each cell represents the maximum consumption rate of a device, it can be seen that the device represented by cell 702a has a much higher maximum consumption rate than the device represented by the cell 702b.

Each cell may be shown in a different color or shading to indicate a characteristic of the device relative to another characteristic of the device. For example, a cell may be shown as green when the current amount of resource being consumed by a device is 20% less than the maximum consumption rate for that device, may be shown in yellow when the device is consuming 10 to 20% less than the maximum consumption rate, and shown in red when the device is consuming lower than 10% below the maximum consumption rate.

Each group label may also be shown in using different colors or shadings to indicate a characteristic of the group of devices relative to another characteristic of the group of devices. For example, the group label may be shown in green when the current amount of resources being consumed by the group of devices 106 is more than a predetermined amount less than the desired group consumption level, and so on.

The visualization module 604 enables a user, through a suitable user input means, such as a mouse, touchpad, touch-sensitive screen, keyboard, etc., to select each cell of the tree map 700 to obtain further details of the characteristics of the device represented by the cell. For example, a user may position a cursor on a cell and the visualization module 604 may display data such as the device ID, the device consumption characteristics, the device consumption data, the device management data, the operating state of the device, and the like.

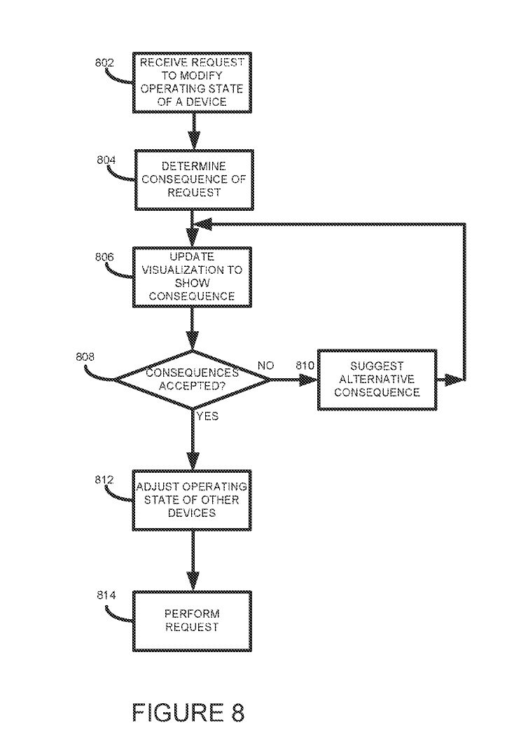

Further operation of the device management system 602 will now be described with additional reference to FIG. 8.

In one example, the visualization system 604 enables a user to request to modify the operating state of a device shown in the tree map 700. For example, by selecting a cell the visualization module 604 may present the user with a menu of options such as ‘power-on device’, ‘power-down device’, ‘change operating state’, etc. At 802 the visualization module 604 receives a request to modify the operating state of a device. At 804, the consumption management module 408 determines the consequences of the request on the other devices 104 in the group of devices 106.

At 806 the visualization module 604 updates the visualization 700 to show the consequence of accepting the request. As already described, the consequence may be visualized by cause the color or shading of one or more of the cells 702 or group labels 704 to be changed, depending on the particular consequence. For example, if accepting the request will cause the group consumption level to exceed a desired maximum level, the group label for that group may be shown in red.

The visualization module 604 then receives (808) an input from the user indicating whether the consequence of the accepting request is acceptable. If the determined consequence is not acceptable to the user, the consumption management module 408 generates an alternative consequence which the visualization module 604 displays (806). As previously described, an alternative consequence may include modifying the operating state of one or more other device, based on device consumption characteristics and device management data.

If, at 808, the visualization module receives a confirmation that the consequences are acceptable, the consumption management module 408 adjusts (812), if appropriate, the operating state of one or more other devices, and performs (814) the request.

It should be noted that the visualization 700 may display data for multiple groups of devices 106. For example, in a hospital environment one group may relate to medical systems, one group to administrative systems, one group to heating, lighting, and air-conditioning systems, etc. In one example the consumption management module 408 may suggest alternative consequences based on devices in any of the groups or sub-groups of devices of an organization.

Examples of the present invention provide a holistic view of resource consumption and enable intelligent management of resource consuming devices. This may be particularly advantageous to an organization and may enable an organization to make importance resource, and hence cost, savings.

For example, in a hospital environment some medical devices, such as magnetic resonance imaging (MRI) scanners, use large amounts of electricity, especially when initially powered-up, but such devices may not be used constantly during a day. For example, if an MRI scanner is used to perform a scan lasting 20 minutes it may be acceptable to modify the operating state of one or more other devices, such as air-conditioning units, for the duration of a high power consumption cycle of the scan, without provoking any negative consequences on the operation of the hospital. At the same time, doing so may enable a more effective management of the electricity consumption.

It will be appreciated that examples of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of tangible machine-readable storage that are suitable for storing a program or programs that, when executed, implement examples of the present invention. Accordingly, examples provide a program comprising code for implementing a system or method as claimed in any preceding claim and a machine readable storage storing such a program. Still further, examples of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. Apparatus for managing a group of resource consuming devices, comprising:
a resource monitoring module to:
obtain resource consumption characteristics of devices in the group of devices; and
obtain a desired consumption characteristic for the group of devices;
and
a device control module to:
receive a request to modify the operating state of a device in the group of devices;
determine the consequence on the desired group characteristic of accepting the request;
determine whether the consequence is acceptable and, where it is so determined, modifying the operating state of the device in accordance with the request.

2. The apparatus of claim 1, wherein the device control module is further arranged to:
determine, where the determined consequence is not acceptable, an alternative acceptable consequence by selecting another device in the group of devices to have its operating state modified;
modify the operating state of the selected device; and
modify the operating state of the requested device in accordance with the request.

3. The apparatus of claim 1, wherein the device control module is further arranged to determine an alternative consequence based on the device consumption characteristics, group consumption data, and desired group resource consumption data.

4. The apparatus of claim 3, wherein the device control module is further arranged to determine an alternative consequence based additionally on device management data of the devices.

5. The apparatus of claim 1, wherein the device control module further comprises a visualization module to:
generate a graphical user interface displaying consumption characteristics of devices in the group of devices;
receive a user selection to modify the operating state of a device;
update the graphical user interface to display the consequence of modifying the operating state of the user selected device;
receive a user confirmation that the displayed consequence is acceptable; and
cause the operating state of the user selected device to be modified in accordance with the request.

6. The apparatus of claim 6, wherein the visualization module is further arranged to:
receive a user confirmation that the displayed consequence is not acceptable;
determine an alternative consequence by selecting another device the operating state of which may be modified to enable the alternative consequence to be acceptable;
update the graphical user interface to display the alternative consequence;
receive a user confirmation that the displayed alternative consequence is acceptable;
modify the operating state of the identified device; and
modify the operating state of the requested device in accordance with the request.

7. A method of managing a group of resource consuming devices, the method comprising:
obtaining a resource consumption characteristic for each of the devices in the group;
determining a desired consumption characteristic for the group of devices;
receiving a request to modify the operating state of a device in the group;
determining the consequence of modifying the operating state of the device on the desired group characteristic; and
determining whether the determined consequence is acceptable, and if so, modifying the operating state of the device in accordance with the request.

8. The method of claim 7, further comprising, where it is determined that the determined consequence is not acceptable;
identifying another one of the devices the operating state of which may be modified to enable the consequence of accepting the request to be determined as acceptable;
modifying the operating state of the identified device; and
modifying the operating state of the device in accordance with the request.

9. The method of claim 7 wherein the step of determining the consequence is based on device consumption characteristics of the device associated with the request, group consumption data, and desired group resource consumption data.

10. The method of claim 8, wherein the step of identifying another one of the devices is based in part on device management data.

11. The method of claim 10, further comprising, prior to modifying the operating state of the device associated with the request:
determining whether the operating state of another one of the devices was previously modified in response to a request being received;
determining whether the operating state of the determined device may be restored to its previous state without the determined consequence being unacceptable; and, where it is so determined, restoring the operating state of the determined device to its previous state.

12. The method of claim 7, further comprising:
generating a visualization including consumption characteristics for the group of devices and devices therein;
receiving, in response to a user interaction with the generated visualization, a request to modify the operating state of a device;
determining the consequence of modifying the operating state of the requested device;
updating the generated visualization to show the determined consequence;
receiving, in response to a user interaction with the updated visualization, a confirmation that the determined consequence is acceptable, and, in response thereto,
modifying the operating state of the requested device in accordance with the request.

13. The method of claim 12, further comprising:
in response to receiving a confirmation that the determined consequence is not acceptable:
determining whether the operating state of a different one of the devices may be modified such that if the operating state of the requested device is modified that determined alternative consequence is acceptable;
further updating the visualization based on the determined alternative consequence; and
receiving, in response to a user interaction with the further updated visualization, a confirmation that the determined alternative consequence is acceptable.

14. A tangible, machine-readable medium that stores machine-readable instructions executable by a processor to provide a method of managing a group of resource consuming devices, the tangible machine-readable medium comprising:
machine readable instructions that, when executed by the processor, obtain a resource consumption characteristic for each of the devices in the group;
machine readable instructions that, when executed by the processor, determine a desired consumption characteristic for the group of devices;
machine readable instructions that, when executed by the processor, receive a request to modify the operating state of a device in the group;
machine readable instructions that, when executed by the processor, determine the consequence of modifying the operating state of the device on the desired group characteristic; and
machine readable instructions that, when executed by the processor, determine whether the determined consequence is acceptable, and if so, modifying the operating state of the device in accordance with the request.

15. The tangible machine-readable medium of claim 14, further comprising:
machine readable instructions that, when executed by the processor, generates a graphical user interface displaying consumption characteristics of the group of devices and devices therein;
machine readable instructions that, when executed by the processor, receive, in response to a user interaction with the generated graphical user interface, a request to modify the operating state of a device;
machine readable instructions that, when executed by the processor, determine the consequence of modifying the operating state of the requested device;
machine readable instructions that, when executed by the processor, update the generated graphical user interface to display the determined consequences;
machine readable instructions that, when executed by the processor, receive a user interaction to confirm that the displayed determined consequence is acceptable; and
machine readable instructions that, when executed by the processor, that modifies the operating state of the requested device in accordance with the request.
